(19) United States
(12) Patent Application Publication
(10) Pub. No.: US 2009/0216601 A1
(43) Pub. Date: Aug. 27, 2009

(54) SCHEDULING TOOL

(76) Inventor: Chethan Anand B.S., Bangalore (IN)

Correspondence Address: EDELL, SHAPIRO & FINNAN, LLC, 1901 RESEARCH BOULEVARD, SUITE 400, ROCKVILLE, MD, 20850, US

(21) Appl. No.: 12/123,581

(22) Filed: May 20, 2008

(30) Foreign Application Priority Data
Feb. 22, 2008 (IN) 445/CHE/2008

(51) Int. Cl. G06Q 10/00; G06F 3/048

(52) U.S. Cl. 705/9; 715/733

(57) ABSTRACT

In one embodiment the invention is a method of scheduling a meeting between a Requestor and one or more Invitees using a computer network. The method operates by defining a work time for the Requestor and each of the one or more Invitees and calculating an international meeting time within the work time of the Requestor and each of the one or more Invitees. The international meeting time is displayed to the Requester when the Requester initiates scheduling of a meeting. If the Requester schedules a meeting outside the international time an alarm is raised.

### FIELD OF THE INVENTION

The present disclosure relates generally to scheduling of meetings via a computer network. In particular, although not exclusively, the disclosure relates to a meeting scheduling tool that defines an international meeting time across time zones.

### BACKGROUND

Communication is key in modern business. It is important for people to meet to discuss aspects of business or to collaborate on a project. This can present a challenge in modern businesses that are conducted across multiple locations, often in different countries. There are various tools available to facilitate communication between people in dispersed locations. It is possible to contact a person virtually anywhere in the world by fixed line or mobile telephone. The internet has enabled immediate communication by email and video conferencing. The barriers to immediate communication are very low.

However, people are very busy and are not often available for a detailed discussion. It is therefore important to be able to schedule a meeting in advance so that all participants can arrange their time to be available at the selected meeting time. Various computer-based meeting scheduling tools are known, the most widely used of which is probably the calendar application in Microsoft Outlook® produced by Microsoft Corporation. Apart from Microsoft Outlook® there are dozens of similar products that all operate in a similar fashion to allow a person to schedule a meeting in a calendar application and invite other people to join the meeting. The calendar applications are typically designed to operate on a personal computer but server installations are also common. In more recent times applications have been written to operate on personal computing devices, such as mobile telephones and personal digital assistants.

Most meeting scheduling tools utilize network resources to facilitate scheduling. The network resources may be an intranet or the Internet. They also use electronic address books to identify contact details for invited participants. Typically a meeting organizer will invite participants by selecting them from an electronic address book (either a local address book accessible only by the meeting organizer or a global address book accessible across an organization) and the scheduling tool will automatically send a meeting invitation to the invitee. Many applications have options to automatically record the meeting in the calendar display of the invitee and the organizer.

Tools and applications are also available to facilitate virtual meetings. U.S. Pat. No. 6,363,352, issued to Microsoft Corporation, describes a tool that works with Microsoft NetMeeting from Microsoft Corporation to schedule a virtually meeting and to automatically start the virtual meeting application at the appropriate time. The patent includes a detailed description of known computer system architecture and network protocols.

One problem common to all the known meeting scheduling tools is difficulty in scheduling meetings between participants located in different time zones. For instance, a person located in San Jose, United States of America may wish to schedule a meeting with a person located in Brisbane, Australia and another person located in Paris, France. A convenient time for the person in San Jose maybe 9 am but this time would be 6 pm in Paris and 3 am in Brisbane. Clearly such a meeting time would be inconvenient to two out of three of the meeting participants.

### BRIEF DESCRIPTION OF THE DRAWINGS

FIG. 1 shows a block schematic diagram of general purpose computer system suitable for implementing a scheduling tool;

FIG. 2 is a schematic showing a network environment that would implement the scheduling tool of the present invention;

FIG. 3 illustrates an example sequence of events for a Requestor to schedule a meeting with Invitees using international time;

FIG. 4 is a pictorial representation of a graphical user interface of a scheduling application incorporating the scheduling tool of the present invention; and

FIG. 5 is an example of a profile data store.

### DESCRIPTION OF EXAMPLE EMBODIMENTS

### Overview

In one embodiment of the invention, a meeting scheduling tool is provided that facilitates scheduling of meetings across multiple time zones.

In another embodiment of the invention, a method is provided for facilitating scheduling of meetings across multiple time zones by calculating an international meeting time from user work times.

In a further embodiment of the invention, a system is provided for calculating an international meeting time from user work times and facilitating scheduling of meetings across multiple time zones using the international meeting time.

### Description

Various embodiments of the invention provide a method and system for facilitating scheduling of meetings across multiple time zones by calculating an international meeting time from user work times. For ease of explanation the invention is described by reference to known meeting scheduling software, such as Microsoft Outlook® from Microsoft Corporation. The invention is not limited to any particular meeting scheduling software. It may be integrated with other meeting scheduling software such as Meeting Place™ and Webex® from Cisco Systems Inc or the like.

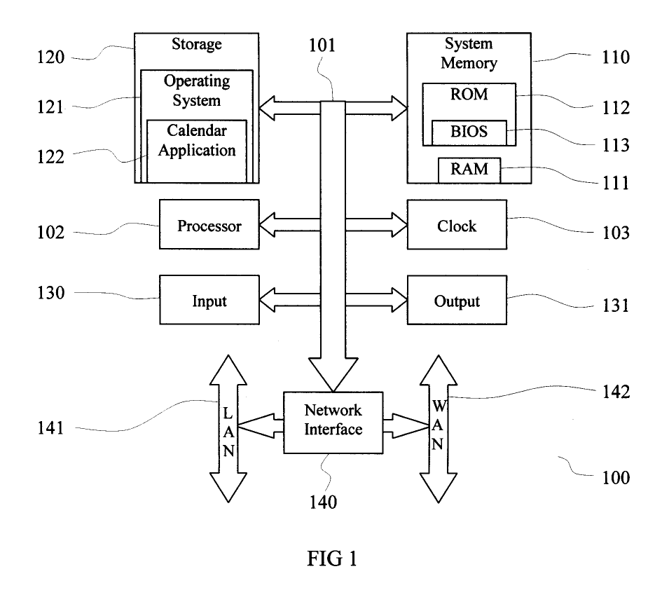

Referring to FIG. 1, a typical general purpose computing device suitable for implementing the invention is shown. The computing device may be a personal computer such as a PC or Mac, or it may be one of the wide range of personal digital assistants (PDA) currently available. The computer 100 includes a system bus 101 that provides signal connection between the various components of the computing device 100. The components of the computing device 100 include a processor 102 and associated system clock 103. System memory 110 includes RAM 111 and ROM 112, which incorporates the BIOS 113. Applications and data are stored in Storage 120. Storage 120 can be one or more of a hard disk drive (HDD), floppy disk drive (FDD), flash card, memory stick, digital versatile disk (DVD) or any of the various forms of storage devices known for use with general purpose computing devices and PDAs.

The storage device 120 typical contains an operating system 121 such as Microsoft Windows®, Linux or Apple Mac OS. In the case of a PDA the operating system may be Palm OS, Symbian, Windows CE or other similar software. The storage device 120 also stores a calendar application 122 that schedules, records and displays appointments. The calendar application may be any one of the numerous applications written to operate with the operating systems outlined above, including the calendar module of Microsoft Outlook®, the calendar application that operates on Palm Treo® and similar products, or iCalc from Apple Inc.

The general purpose computing device also includes one or more input devices 130 and one or more output devices 131. Input devices 130 may include a keyboard, mouse, microphone jack and Bluetooth™ port. Output devices 131 may include a video card for connection to a video display, a sound card for connection to speakers or other audio devices, and various parallel and serial ports for connection to printers and other external devices.

Most general purpose computing devices 100 also include one or more network interface devices 140 for connection to a local area network 141 and/or a wide area network 142. Persons skilled in the art will appreciate that modern computing environments encompass stand-alone computers that connect to a LAN or WAN for communication purposes (e.g. Email) or to access centralized resources. The computers may also be dumb terminals that utilize remote display protocols to provide a local display of a terminal session running on a central server. The invention can operate in any of these environments, under any operating system and with any calendar application.

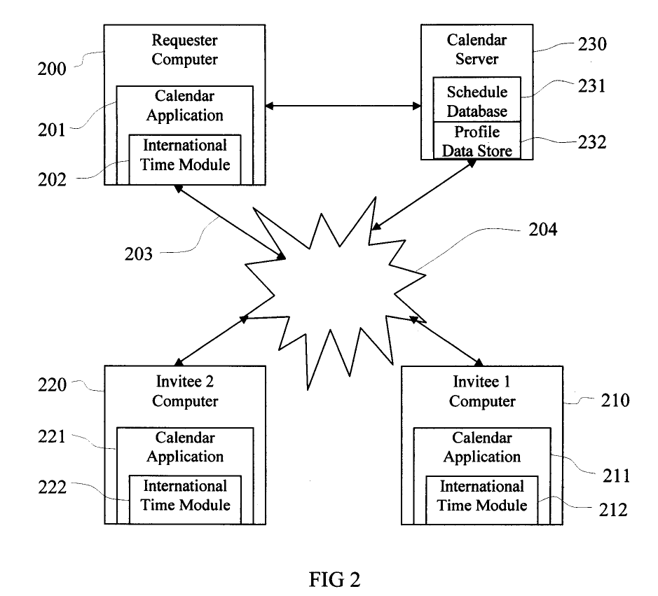

Referring to FIG. 2 there is shown a requester computer 200, which may be any one of the general purpose computing devices described above. A calendar application 201 is running on the computer 200. A component 202 of the calendar application 201 handles meeting scheduling using international time as described in detail herein. As described above, the computer 200 is connected 203 to a network, 204, such as the Internet. The calendar application 201 records and displays meetings and other events based on information input by a user or received via the network. For the purposes of the following discussion it is assumed that the Requester computer 200 is being operated by a Requester seeking to establish a meeting with a number of Invitees.

Also shown in FIG. 2 is Invitee1 computer 210 that is running a calendar application 211 with a component 212 of the calendar application 211 which handles meeting scheduling using international time as described in detail herein. There is also shown Invitee2 computer 220 that is running a calendar application 221 with a component 222 of the calendar application 221 which handles meeting scheduling using international time. It is usual for calendar applications 201, 211 and 221 to be the same software application, but this is not essential providing they are using the same communication and scheduling protocols, or have suitable embedded translation modules.

As will be familiar to most people, the Requester computer 201 sends a meeting request to one or more Invitees, such as 210, 220, using known communication protocols. The Invitee computers 210, 220 process the request and return a message either declining, accepting or tentatively accepting the meeting request. The decision may occur automatically or may be based on input from the Invitee. The meeting is then scheduled by recording the time of the meeting, the location of the meeting, the subject and the attendees in the calendar application of each of the participants.

It will be appreciated that the calendar applications 201, 211, 221 are active when the Requester Computer 200, Invitee Computer 210 and Invitee Computer 220 are on, respectively. Meeting requests are therefore not processed unless, or until, the computers are on. To overcome this problem it is common for a calendar server 230 to maintain a schedule database 231 that records all meetings for all users connected to the calendar server 230. The Calendar Server 230 holds meeting requests until the relevant computer is available to process the request. It is also possible for default actions to be set up so that meeting requests are processed by the Calendar Server 230, even if the relevant computer is off. The Calendar Server 230, may also maintain user profiles 232, described in detail below. Persons skilled in the art will recognize that such an application is Microsoft Exchange Server® but other similar server applications exist for other meeting protocols.

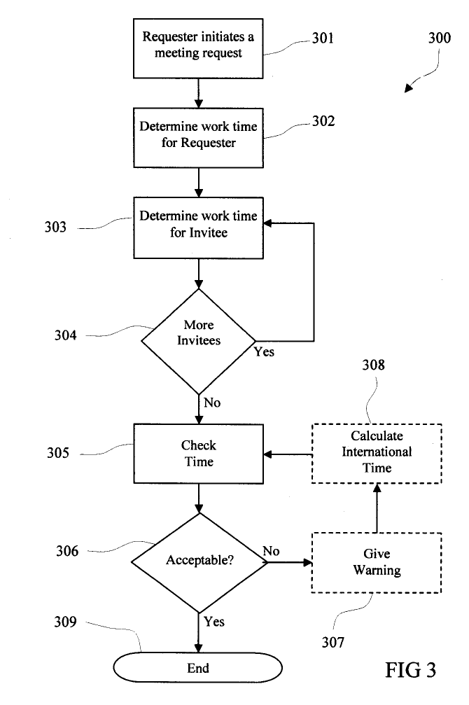

FIG. 3 displays a flowchart 300 of the sequence of events for scheduling a meeting using international time. A Requester using the international time module 202 initiates a meeting request 301 in the appropriate manner for the calendar application 201 being used. The international time module 202 determines the work time 302 for the Requester from a profile 232 which may have been previously established by the Requester or may be a default profile for the Requester's work location. The work time may include core work time, typically 0800 to 1800 local time, and available work time, typically 0600 to 0800 and 1800 to 2200 local time. Rest time, typically 2200 to 0600, is not selectable. In similar manner the international time module 212 determines the work time 303 for an Invitee1.

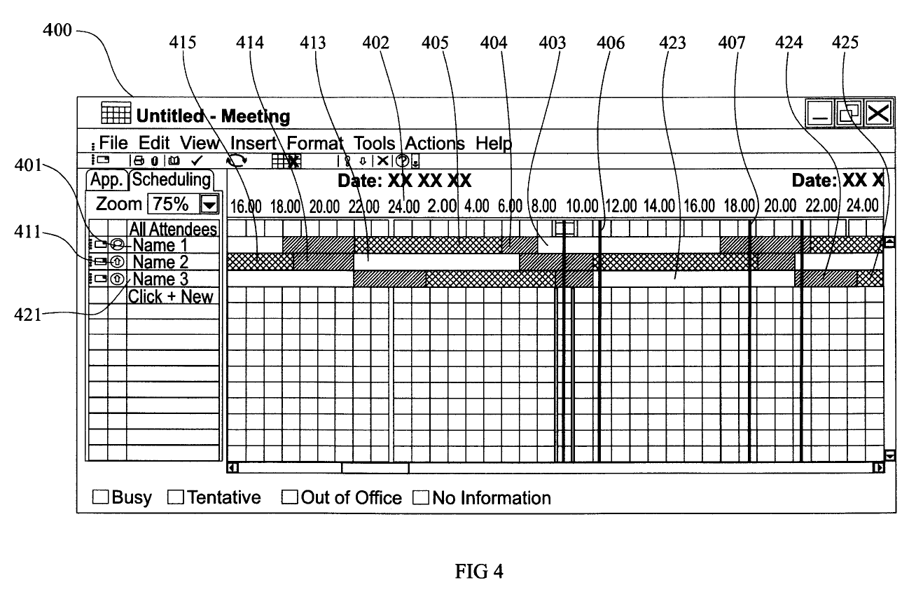

If the meeting is to include additional invitees, the Requester invites 304 further invitees to the meeting until all invitees are included. For instance, work time for Invitee2 is determined by the international time module 222 on the computer 220 of Invitee2. The scheduling module calculates work time 305 for all the invitees. As discussed with respect to FIG. 4 below, the international time module 202 integrates with the calendar application 201 to display the work time for the Requester and each Invitee in the calendar application display of the Requestor. The Requester typically reviews the display and selects a suitable meeting time that is convenient for the Requester and all Invitees.

If the Requester proposes a meeting time that includes a Rest Time for one or more Invitees the international time module 202 identifies the meeting time as not acceptable 306. The international time module 202 may optionally raise an alarm 307 to alert the Requester of the problem. The alarm may be audible, visual or both. For example, the alarm may be in the form of a sound that the User recognizes as indicating an error, such as a ‘bong’. In another form the alarm may be a warning message that appears in a pup-up window. Alternatively, the international time module 202 may be configured to automatically select a suitable meeting time 308 that is either proposed to the Requester or automatically sent to all Invitees. If the automatically selected meeting time is proposed to the Requester, the Requester may elect to accept the proposed time or to propose an alternate time.

The process ends 309 when the meeting request has been sent to all Invitees. The handling of meeting proposal responses is an existing function of known calendar applications.

To assist the Requester in selecting a suitable meeting time the international time module 202 displays a calendar view that shows a coded calendar for each Invitee. In one embodiment the calendar view shows core work time coded in green, non-core work time coded in yellow and rest time coded in red. In addition, any existing appointments are shown blocked out, as is conventional in calendar applications. It is then convenient for the Requester to propose a meeting time that is green for all invitees, or if this is not achievable at least green for most invitees and yellow for some invitees.

Similarly, the international time module 212 displays a calendar view that shows a color-coded calendar for Invitee1, the Requester and any other Invitees. The international time module 222 displays a calendar view that shows a color-coded calendar for Invitee2, the Requester and other Invitees

In another embodiment, shown in FIG. 4, core work time is coded clear, non-core work time is coded in single hash and rest time is coded in double hash Referring to FIG. 4, the Requester 401 is shown towards the top of the screen 400 with local time displayed across the top 402. Coded bars indicate core work time 403, available work time 404 and rest time 405. For ease of display the rest time 405 is shown as double hatched, the available work time 404 is shown hatched and the core work time 403 is not hatched. Invitee1 411 is shown below the Requester with a similar display for work time 413, available work time 414 and rest time 415. Similarly, Invitee2 421 is shown below Invitee1 with a similar display for work time 423, available work time 424 and rest time 425.

For the purpose of discussion it will be assumed that Requester 401 is located in Bangalore, India, that Invitee1 411 is located in San Jose, Calif., and Invitee2 421 is located in Netanya, Israel. Due to the time difference between these three cities it is difficult for the Requester to schedule a meeting that is at a time that is convenient for the Requester and for Invite1 and Invitee2. For example, if Requester 401 wanted to schedule a meeting 406 for 0900 Monday morning the time would be available work time in San Jose but it would overlap rest time in Netanya. If the meeting were set for 1100 in Bangalore it would be available work time going into core work time in Netanya but would overlap rest time in San Jose. These problems would not be immediately apparent to the Requester in the absence of embodiments of the present invention. Without an implementation of the invention the Requester would need an exchange a series of emails to try and schedule the meeting. Given that the aim is to have the meeting on a Monday morning it would be necessary to commence the process of trying to schedule a meeting at least a week in advance of the preferred meeting time. Clearly this is impossible if a meeting is to be scheduled urgently.

Referring to FIG. 4, it can be seen that a suitable international time for scheduling the meeting is any time during international time 406 between 0930 and 1130 in Bangalore. This is in core time for the Requester 401 and available time for both Invitee1 and Invitee2. If the meeting were set for 1000 to 1100 in Bangalore it would be 2030 to 2130 in San Jose and 0630 to 0730 in Netanya. An alternate international time 407 is between 1930 and 2200. This is in available time for the Requester 401 and in core time overlapping available time for Invitee1 and Invitee2.

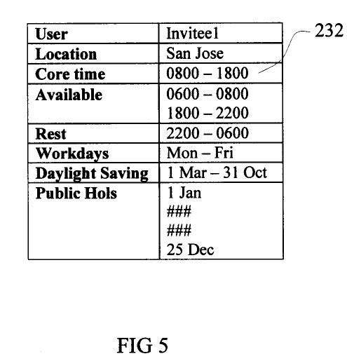

The display of international times is determined from a profile for each User. One embodiment of a data structure of a profile 232 is displayed in FIG. 5. The profile may be stored locally or, as discussed above, stored on a server to facilitate offline meeting scheduling. The embodiment displayed in FIG. 5 represents that each individual User has a profile. The profile identifies the User, in this case Invitee1, as well as the location of the User, in this case San Jose. The core work time, available work time and rest time is contained in the profile. These times may be fixed by an organization or may be variable by the User. The profile also contains the normal work days. As shown for Invitee1 in San Jose, the normal work days are Monday to Friday. For Invitee2 in Netanya the normal work days will be Sunday to Friday. Whether time is changed for daylight saving is also recorded together with the standard public holidays for the location. Persons skilled in the art will recognize some of the profile information, such as public holidays and daylight saving, to be obtainable from profiles in known systems, such as Microsoft Outlook®.

In a different embodiment the profile is a common profile for a location that provides standard information for all Users at that location. A User is considered to be at a location when they connect to the location via a LAN. Different protocols may apply for Users who routinely access a WAN for scheduling meetings. The Inventor considers that a useful implementation is to provide a default profile based on location but to allow a User to adjust their profile as desired. This accounts for individual preferences, such as some people preferring to work early and other people preferring to work late.

Although the preferred embodiment has been described in terms of scheduling meetings between Users in different time zones it will be appreciated that the invention may also be employed to schedule meetings between Users in the same time zones who have different preferred work time.

In a yet further embodiment the profile is configurable for temporary variation from a normal profile. For instance, when a User schedules a trip away from their regular location the profile is temporarily adjusted to account for the change in location. This can occur automatically by the User recording a log of locations as the trip itinerary is determined. The default profile for each location is made available for responding to meeting requests made when the User is on the trip. This embodiment avoids the problem of scheduling a meeting at a convenient time in a normal location that ends up being during a rest time because the Invitee has traveled to a new location between the time of scheduling the meeting and the time of attending the meeting.

In the foregoing specification, although the invention has been discussed with reference to specific embodiments, these embodiments are merely examples for purposes of illustrations, rather than restrictive, of the invention. For example, one of ordinary skill in the art will appreciate that any calendar application can be employed and that the international time module can be implemented as a plug-in, an add-in, or as a stand-alone application.

Although specific example procedures have been used to illustrate various embodiments, those skilled in the art will also appreciate that embodiments of the present invention can use other methods, procedures or standards. Use of the terms “Requester”, “Invitee”, “database”, “server”, “storage”, “module”, “interface”, and the like can include any type of device, operation, or other process that performs the described function.

In addition, any suitable specification language can be used to implement methods and computer readable program code components of the present invention including workflow definition languages, VHDL, Verilog, C, Java, etc. The implementations can execute using a variety of processor, non-processor approaches or a combination of the two approaches, such as central processing on a single processor or multiprocessors, distributed processing, parallel processing, signal processing by a digital signal processor (DSP), a virtual processing on a Java virtual machine, or custom logic on FPGA or ASIC. The implementations can execute on a variety of types environments interacting and/or sharing resources with other entities or processes, such as a work flow engine, a Web server, an operating system, a Java virtual machine, etc.

Thus, while the present invention has been described herein with reference to particular embodiments thereof, other variations and embodiments are possible in light of above descriptions, and it is thus intended that the scope of invention defined solely by claims following including any amended claims made during this application. It is also intended that the invention not be limited to the particular terms used in the following claims, but that the invention will include any and all embodiments and equivalents falling within the scope of the following claims.

We claim:

1. A method of scheduling a meeting using a computer network comprising: defining a work time for a Requestor and each of one or more Invitees; calculating an international meeting time within the work time of the Requestor and each of the one or more Invitees; and displaying the international meeting time to the Requester when the Requester initiates scheduling of a meeting.

2. The method of claim 1, wherein the work time is automatically set according to a user profile.

3. The method of claim 1, wherein the work time is automatically set according to a location profile.

4. The method of claim 1 further comprising displaying core work time, available work time and rest time to the Requester.

5. The method of claim 4 wherein the core work time, available work time and rest time are displayed using color coding.

6. The method of claim 1 further comprising displaying international meeting time to each of the one or more Invitees.

7. The method of claim 1 further comprising displaying core work time, available work time and rest time to each of the one or more Invitees.

8. The method of claim 1, further comprising raising an alarm if the Requester schedules a meeting not in the international meeting time.

9. The method of claim 8 wherein the alarm is an audible alarm.

10. The method of claim 8 wherein the alarm is a visual alarm.

11. The method of claim 8 wherein the alarm is a visual alarm in the form of a warning in a pop-up window.

12. The method of claim 1, further comprising automatically scheduling a meeting between the Requester and the one or more Invitees within the international meeting time.

13. The method of claim 1, wherein the work time is defined by day and hour.

14. The method of claim 1 wherein the Requester and the one or more Invitees are in different time zones.

15. An apparatus comprising:
a work time for each of a Requestor and one or more Invitees;
a time calculator to calculate an international meeting time within the work time of the Requestor and the one or more Invitees; and
a scheduler to access the international meeting time to influence scheduling of a meeting between the Requestor and the one or more Invitees.

16. The apparatus of claim 15, further comprising:
means for providing an alarm to the Requester if the Requester schedules a meeting outside the international meeting time.

17. The apparatus of claim 15 further comprising means for displaying the international meeting time to the Requester.

18. The apparatus of claim 15 further comprising means for displaying the international meeting time to each of the one or more Invitees.

19. A system comprising:
a calendar application running on a computing device connected to a network; and
computer readable program code components stored on the computing device operable when executed to calculate an international meeting time for scheduling meetings between a Requester and one or more Invitees by:
defining a work time for the Requestor and each of the one or more Invitees;
calculating an international meeting time within the work time of the Requestor and each of the one or more Invitees; and
displaying the international meeting time to the Requester when the Requester initiates scheduling of a meeting.

20. The system of claim 19 further comprising computer readable program code components stored on the computing device configured to raise an alarm if the Requester schedules a meeting outside of the international meeting time.
